(19) United States
(12) Patent Application Publication
(10) Pub. No.: US 2004/0159587 A1
(43) Pub. Date: Aug. 19, 2004

(54) Apparatus and method for separating/mixing particles/fluids

(76) Inventor: Michel Couture, St-Andre d'Argenteuil (CA)

Correspondence Address: OGILVY RENAULT, 1981 MCGILL COLLEGE AVENUE, SUITE 1600, MONTREAL, QC, H3A2Y3, CA

(21) Appl. No.: 10/776,176

(22) Filed: Feb. 12, 2004

(30) Foreign Application Priority Data
Feb. 12, 2003 (CA) 2,421,246
Feb. 21, 2003 (CA) 2,419,451
Jul. 18, 2003 (CA) 2,435,086

(51) Int. Cl. B07B 1/00

(52) U.S. Cl. 209/132

(57) ABSTRACT

An apparatus and method for separating a particle stream into particle groups, comprising a dilution treatment chamber defining an upstanding channel to receive a particle stream, such that the particle stream falls toward a first-particle-group outlet. A transfer casing is adjacent to the dilution treatment chamber and defines a transfer chamber to receive a second particle group. Second-particle-group outlets are laterally positioned with respect to the channel and allow fluid communication therebetween. A distributor in the channel is provided to break down the particle stream and to distribute the particle stream over a surface area of the channel. Fluid flow apertures create a fluid flow between the transfer chamber and the channel so as to entrain a second particle group to the transfer chamber with a first particle group remaining in the channel for exiting through the first-particle-group outlet. The apparatus and method is also used to mix/treat particle streams/fluids.

This application claims priority on Canadian Patent Applications No. 2,421,246, filed on Feb. 12, 2003, No. 2,419,451, filed on Feb. 21, 2003, and No. 2,435,086, filed on Jul. 18, 2003.

### BACKGROUND OF THE INVENTION

1. Field of the Invention

The present invention generally relates to the separation and mixing of particles and, more specifically, to a dry particle stream separator/mixer and methods for separating particle streams into particle groups and for mixing/treating particle groups.

2. Background Art

Previously known techniques and methods are currently used for the separation of aggregates into particle groups. For instance, gravity classifiers, inertial classifiers, centrifugal classifiers, and cyclone separators are well known and used technologies. Amongst other patents, Canadian Patent No. 2,257,674, issued on Jan. 7, 2003 to Cordonnier et al., discloses an air classifier with centrifugal action. Canadian Patent Applications No. 2,068,935 (by Tyler et al.) and 2,294,829 (by Gruenwald) respectively describe an air separator and an air classification of water-bearing fruit and vegetable ingredients for peel and seed removal and size discrimination.

Another known separation method is gravity separation by elutriation. In this process, a predetermined particle group is lifted by an airflow against the force of gravity. A finer particle group is collected by an upwardly positioned collector, whereas coarser particles overcome the airflow to be collected at a downwardly positioned collector. The velocity of air has a direct effect on the particle group that is collected by the upwardly positioned collector.

This previously described method is a dry process, in that the fluid used for the separation is not in a liquid phase. Such systems are advantageous in that no liquid is polluted in the separation process. The cleaning of liquids after particle separation is a costly process, and this results in a clear cost-efficiency advantage for dry processes.

### SUMMARY OF INVENTION

It is therefore an aim of the present invention to provide a novel apparatus for separating a particle stream into particle groups.

It is a further aim of the present invention to cause a dilution of a particle stream to enhance the separation of the particle stream into particle groups.

It is a further aim of the present invention to provide a novel apparatus for mixing particle groups into a particle stream.

It is a further aim of the present invention that the apparatuses for separating a particle stream into particle groups, and for mixing particle groups into a particle stream use minimum space and air volume so as to be cost and space efficient.

It is a further aim of the present invention to provide a novel method for separating particle streams into particle groups.

It is a further aim of the present invention to provide a novel method for mixing particle groups.

It is a further aim of the present invention to reduce a need for conventional dust collection systems.

A few factors are considered in creating separation equipment. For instance, it is desired that the amount of fluid used in the process be kept low. The fluid that is used for the separation will lose the particles it carries in suspension by settling.

Also, the separation is a sub-process of larger processes, and is often performed in limited-space areas with the larger process. It is therefore desired to keep the dry-separation equipment as space efficient as possible.

Therefore, in accordance with the present invention, there is provided an apparatus for separating a particle stream into particle groups, comprising a dilution treatment chamber defining an upstanding channel having a particle inlet at a top end, and a first-particle group outlet at a bottom end, the channel being adapted to receive a particle stream at the particle inlet such that the particle stream falls toward the first-particle-group outlet; a transfer casing adjacent to the dilution treatment chamber and defining a transfer chamber adapted to receive a second particle group; at least one second-particle-group outlet laterally positioned with respect to the channel of the dilution treatment chamber and allowing fluid communication between the transfer chamber and the channel; a distributor in the channel between the particle inlet and the at least one second-particle-group outlet, for breaking down the particle stream and distributing the particle stream over a surface area of the channel; and at least one fluid flow aperture in the dilution treatment chamber and below the distributor, adapted to create a fluid flow between the transfer chamber and the channel so as to entrain a second particle group from the channel through the second-particle-group outlet to the transfer chamber with a first particle group remaining in the channel for exiting through the first-particle-group outlet, the apparatus being adapted to be connected to a positive pressure source to create the fluid flow.

Further in accordance with the present invention, there is provided a method for separating a particle stream into particle groups, comprising the steps of: i) breaking down the particle stream by subjecting the particle stream to lateral forces; ii) vertically diluting the particle stream by directing the particle stream to a falling condition; iii) entraining a particle group away from a remainder of the particle stream by creating a fluid flow of predetermined magnitude across the particle stream in said falling condition; and iv) collecting the particle group and the remainder of the particle stream at separate locations.

Still further in accordance with the present invention, there is provided an apparatus for at least one of mixing and treating particle and/or fluid streams, comprising a dilution treatment chamber defining an upstanding channel having an inlet at a top end, and an outlet at a bottom end, the channel being adapted to receive said particle and/or fluid streams at the inlet such that said particle and/or fluid streams fall toward the outlet; at least one fluid flow aperture in the dilution treatment chamber, adapted to create a generally lateral flow of at least one of a fluid and particle jet within the channel to create a turbulence in the channel for at least one of mixing said particle and/or fluid streams and treating said particle and/or fluid streams, whereby a mixture and/or treated matter will exit the channel at the outlet; and a positive pressure source connected to the fluid flow aperture to create the lateral flow of the at least one of the fluid and the particle jet.

Still further in accordance with the present invention, there is provided a method for at least one of treating and mixing particle and/or fluid streams, comprising the steps of: i) vertically diluting particle and/or fluid streams by directing particle and/or fluid streams to a falling condition; ii) creating a lateral flow of fluid and/or a particle jet across the particle and/or fluid streams in said falling condition for at least one of mixing the particle and/or fluid streams by a turbulence resulting from the lateral flow of fluid and/or particle jet, and treating said particle and/or fluid streams; and iii) collecting the mixture and/or treated matter below the lateral flow.

### BRIEF DESCRIPTION OF THE DRAWINGS

Having thus generally described the nature of the invention, reference will now be made to the accompanying drawings, showing by way of illustration a preferred embodiment thereof and in which:

FIG. 1 is a schematic view of an apparatus for separating a particle stream in accordance with a preferred embodiment of the present invention, and of a method for separating the particle stream;

FIG. 2 is a perspective view of the apparatus in accordance with a preferred embodiment of the present invention;

FIG. 3 is a further perspective view of the apparatus of FIG. 1;

FIG. 4 is a perspective view of a nozzle to be used with the apparatus of the first embodiment;

FIG. 5 is a perspective view of the apparatus in accordance with a second embodiment of the present invention;

FIG. 6 is a perspective view of a lateral particle separator to be used with the apparatus of the second embodiment;

FIG. 7 is a perspective view of a recuperator tray of the apparatus;

FIG. 8 is a schematic view of an impeller used to create horizontal dilution and separation of a particle stream in accordance with an alternative embodiment of the present invention;

FIG. 9 is a schematic view of a laterally reciprocating strainer in accordance with a further alternative embodiment of the present invention; and

FIG. 10 is a schematic view of an apparatus for separating a particle stream in accordance with a still further alternative embodiment of the present invention.

### DESCRIPTION OF THE PREFERRED EMBODIMENTS

It is pointed out that the present invention is associated with the separating and mixing of particles. The term particle stream is broadly used herein to designate a mass of particles, granules, pellets, and other elements of different mass and volume gathered together. Various uses of the present invention are defined hereinafter, for which the mass that is separated/mixed is referred to as particle stream, unless stated otherwise.

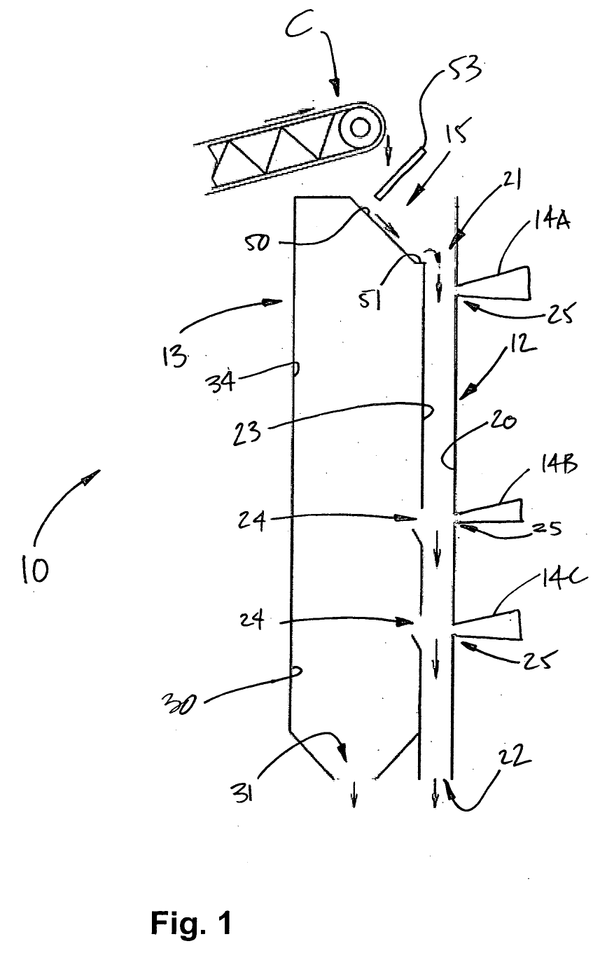

Referring to the drawings, and more particularly to FIG. 1, an apparatus for separating a particle stream into particle groups is generally shown at 10. The apparatus 10 has a dilution treatment chamber 12, a transfer casing 13 adjacent to the dilution treatment chamber 12, nozzles 14 serially mounted on the dilution treatment chamber 12, and a pretreatment module 15. It is pointed out that the nozzles 14 are affixed with letters in various figures, whereby reference to the nozzles 14 will relate to all nozzles (e.g., nozzles 14A, 14B and 14C), while reference to a specific one of the nozzles will include an affixed letter.

The dilution treatment chamber 12 performs a dilution of a particle stream by gravity, and hosts a step of separation of the particle stream into particle groups.

The transfer casing 13 is in fluid communication with the dilution treatment chamber 12 and receives a particle group separated from the remainder of the particle stream in the dilution treatment chamber 12.

The nozzles 14 are used to inject fluid (to be discussed hereinafter) which breaks down the mass of particle stream and/or enhance the dilution of the particle stream in the dilution treatment chamber 12. Moreover, the nozzles 14 are used to inject fluid which separates the particle stream into the particle groups.

The pretreatment module 15 is used to guide and accelerate the particle stream toward the dilution treatment chamber 12, such that the particle stream will have some velocity. The velocity will cause a horizontal dilution of the particle stream.

Dilution Treatment Chamber 12

Referring concurrently to FIGS. 1, 2 and 3, the dilution treatment chamber 12 is shown having an upstanding elongated shape, and defines a vertical channel 20 of rectangular cross-section. Although a rectangular cross-section is described, any other suitable cross-section shapes are contemplated. The channel 20 has an inlet 21 at a top end thereof and an outlet 22 at a bottom end thereof. The dilution treatment chamber 12 shares a wall 23 with the transfer casing 13. Lateral outlets 24 are provided in the wall 23, such that the dilution treatment chamber 12 and the transfer casing 13 are in fluid communication. Moreover, the dilution treatment chamber 12 may vary in cross-sectional dimensions. For instance, appropriate translating mechanisms may be provided so as to increase/decrease a length or width of the cross-section parameters of the dilution treatment chamber 12.

The dilution treatment chamber 12 also has pressure-differential apertures 25 (herein three apertures, i.e., fluid flow apertures), two of which are horizontally opposite the lateral outlets 24 in the wall 23.

Transfer Casing 13

Referring concurrently to FIGS. 1, 2 and 3, the transfer casing 13 defines an inner transfer chamber 30. The inner transfer chamber 30 has a funnel-shaped outlet 31 at a bottom end thereof, so as to collect a particle group in suspension in the transfer chamber 30.

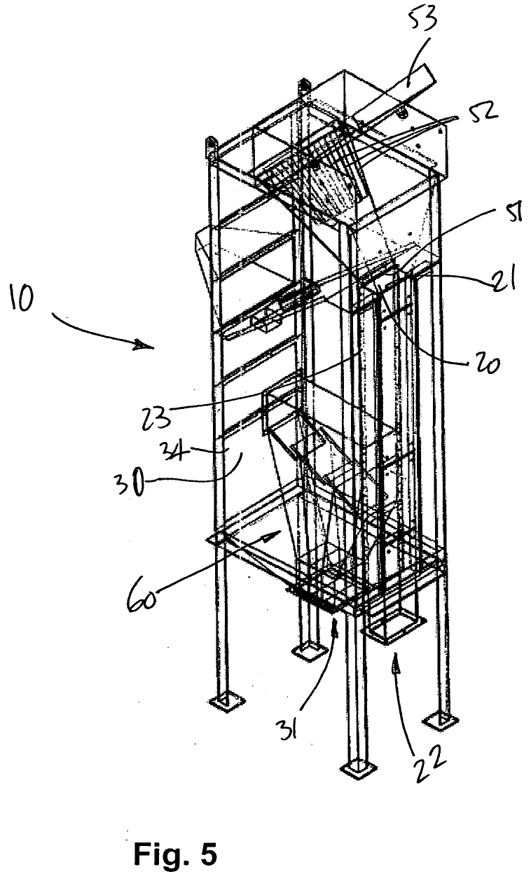

Referring to FIG. 5, a lateral particle separator 60, in accordance with another embodiment of the present invention, is received in the transfer chamber 30 of the transfer casing 13. The lateral particle separator 60 will be described in further detail hereinafter, and is used to cause a further particle group separation.

Nozzles 14

Referring concurrently to FIGS. 1, 2 and 3, the nozzles 14B and 14C are positioned opposite the lateral outlets 24 of the dilution treatment chamber 12. The nozzles 14, in a preferred configuration, are connected to a pressure source so as to inject a gaseous fluid (e.g., air or any other suitable gas, whereby reference will be made non-restrictively hereinafter to air or gaseous fluid) into the channel 20 of the dilution treatment chamber 12.

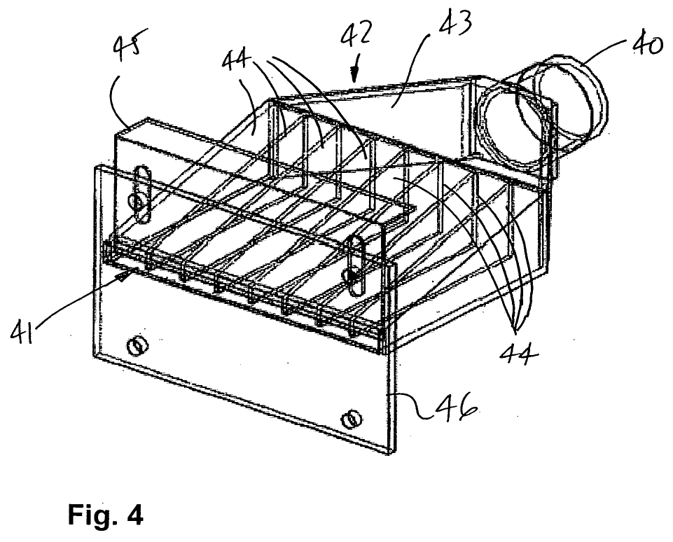

Referring to FIG. 4, one of the nozzles 14 is illustrated in greater detail. The nozzle 14 has an inlet 40, by which it is connected to a pressure source, and an outlet 41 of elongated rectangular shape. The nozzle 14 has, a diffusing body 42 between the inlet 40 and the outlet 41.

In a preferred embodiment of the present invention, the diffusing body 42 has an accumulator portion 43 connected to the inlet 40, and tapered diffusing sectors 44 between the accumulator portion 43 and the outlet 41. The diffusing sectors 44 are used in order to create a substantially uniform diffusion of air out of each of the nozzles 14.

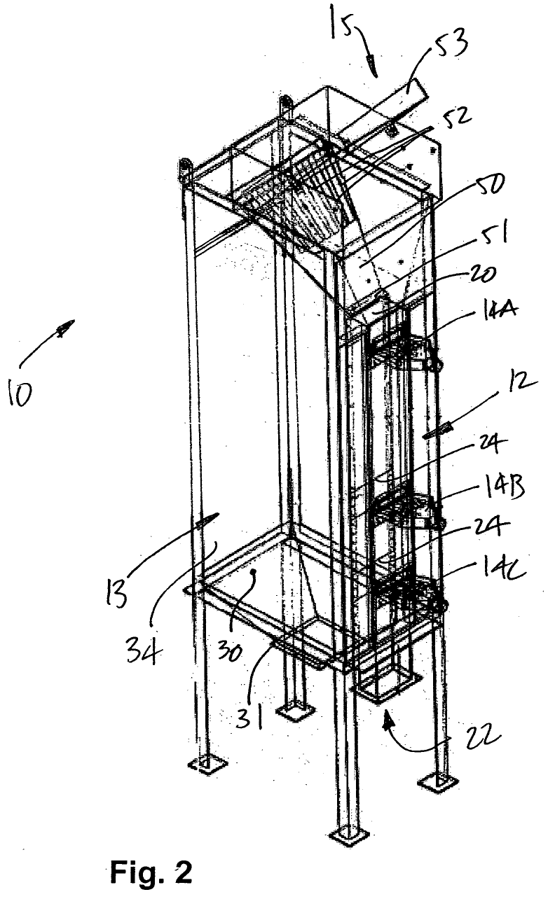

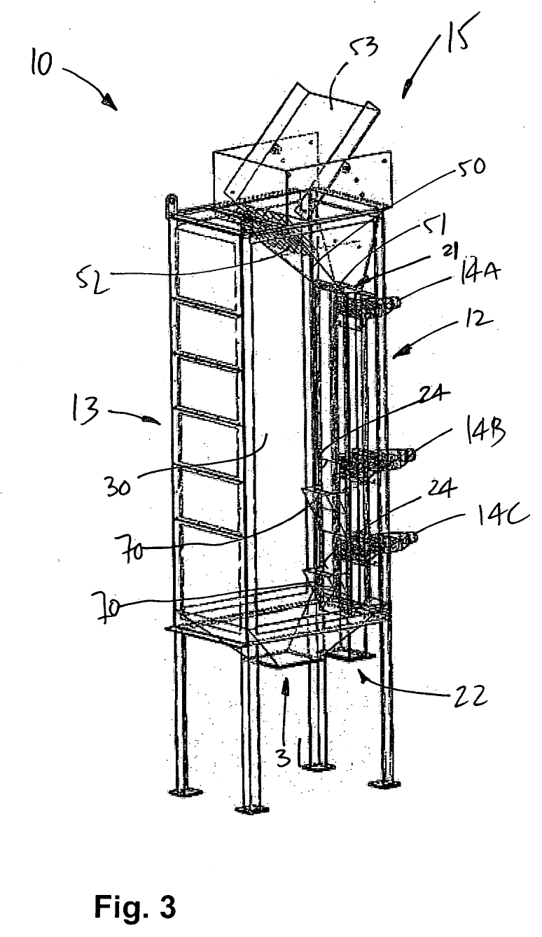

A gate 45 is displaceable vertically for the adjustment of the height of the outlet 41. A connection flange 46 is used to secure the nozzle 14 to the dilution treatment chamber 12 opposite the pressure-differential apertures 25. It is also seen in FIGS. 2 and 3 that the gate 45 can be accessed from an exterior of the apparatus 10, thereby enabling the rapid adjustment of the outlet size of the nozzles 14 from an exterior of the apparatus 10.

The above-described configuration of the nozzle 14 enables a high-pressure, low-volume output of gaseous fluid into the dilution treatment chamber 12 to produce a high impact on the particle stream. Accordingly, the output of gaseous fluid will decelerate at a high rate, so as to entrain in some instances described hereinafter a given particle group out of the dilution treatment chamber 12, and to avoid enhancing turbulence in the transfer chamber 30. Such turbulence would slow down the settling process in the transfer chamber 30, for instance, if the apparatus 10 were used for classifying particle groups.

Pretreatment Module 15

Referring concurrently to FIGS. 1, 2 and 3, the pretreatment module 15 is positioned at the inlet 21 of the dilution treatment chamber 12. The pretreatment module 15 conveys the particle stream from a particle stream source, such as conveyor C, to the inlet 21 of the dilution treatment chamber 12. More specifically, the pretreatment module 15 will be used to produce specific inlet conditions for the particle stream.

In a preferred embodiment of the present invention, the pretreatment module 15 has a slide 50, sloping downwardly towards the inlet 21 of the dilution treatment chamber 12. A deflector 51 is positioned between the slide 50 and the inlet 21 of the channel 20. The deflector 51 has a generally horizontal launch surface, but may also be oriented otherwise. As seen in FIGS. 2 and 3, the slide 50 tapers towards the inlet 21 of the dilution treatment chamber 12, so as to have an outlet width generally equal to the inlet width of the channel 20 of the dilution treatment chamber 12. The slide 50 is preferably provided with guiding rails 52 (FIGS. 2 and 3). The particle stream reaching the slide 50 is preferably uniformly distributed toward the inlet 21 of the dilution treatment chamber 12, and the guiding rails 52 are provided to this effect.

A further slide 53 is optionally provided above the slide 50 so as to dampen the fall of the particle stream from the conveyor C. The slide 53 will absorb a portion of the downward force, and will absorb the lateral velocity transmitted from the conveyor C to the particle stream, such that the particle stream reaches the dilution treatment chamber 12 at predetermined velocity parameters.

It is contemplated to provide various geometries to the pretreatment module 15. For instance, the slide 50 is herein illustrated as being generally a flat, inclined surface. However, it is contemplated to provide the slide 50 with a downwardly-tapered frusto conical shape, whose smallest cross-section would meet the inlet 21 of the dilution treatment chamber 12. Moreover, for such an embodiment, the slide 53 preferably has an upright conical shape.

The Operation of the Apparatus in Separation

Now that the various components of the apparatus 10 have been described, a separation operation of the apparatus 10 is set forth.

Referring concurrently to FIGS. 1, 2 and 3, a particle stream is fed by the conveyor C to the apparatus 10. The particle stream has a lateral velocity and will accelerate downwardly when leaving the conveyor C due to gravitational forces.

The slide 53 will absorb a portion of the downward force of the particle stream, and stop the lateral velocity of the particle stream that had been transferred to the particle stream by the action of the conveyor C. The mass of particle stream is directed by the slide 53 toward the slide 50 of the pretreatment module 15, at generally predetermined velocity conditions.

Upon reaching the slide 50, the particle stream will be guided by the guiding rails 52 so as to be conveyed uniformly towards the dilution treatment chamber 12 as a result of the downward slope of the slide 50. The downward slope of the slide 50 will cause the particle stream to accelerate.

The deflector 51, having a launch surface, will deflect the particle stream so as to initiate a break-up of the mass of particle stream. A lateral dilution will be the result of the deflection of the particle stream by the deflector 51. Accordingly, the particle stream will reach the dilution treatment chamber 12, having been subjected to a mass break-up and to a horizontal dilution.

The particle stream then falls in the channel 20 of the dilution treatment chamber 12. The gravity will cause a vertical dilution of the particle stream.

A first one of the nozzles, namely nozzle 14A, will inject air within the channel 20 of the dilution treatment chamber 12 so as to cause a break-up of the mass of particle stream into particle groups (i.e., breaking down the mass of particle stream) and spread out, dilute and/or create space between particle groups. This nozzle 14A is also referred to as a distributor, as it will be distributing the particle stream over a surface area of the channel 20. As alternative distributors, the apparatus 10 may be provided with vibrating strainers, impellers or the like, as will be illustrated hereinafter.

The particle stream, having been subjected to a horizontal and a vertical dilution (i.e., break-up or distribution), will be crossing a horizontal flow of air as injected by the second nozzle 14B, and the optional third nozzle 14C. The nozzles 14B and 14C inject air at a predetermined pressure through the apertures 25, which are opposite the lateral outlets 24, such that the air will carry the finer-particle group out of the channel 20, through the lateral outlets 24, and into the inner transfer chamber of the transfer casing 13, in a high particle to air concentration. The air injected by the nozzles 14 is at the predetermined pressure, such that the coarse particle group will not be entrained out of the channel 20 by the air flow. The dilution that has taken place previously is an important factor in the separation of the fine particles from the coarse particles. The magnitude of the pressure of air injection will have a direct effect on the particles being withdrawn from the particle stream in the channel 20. It is pointed out that the vertical distance from the inlet 21 to the nozzle 14B is an essential factor in diluting the particle stream to facilitate the subsequent separation of the particle groups so as to increase fluid/particle contact.

Although three nozzles (namely 14A, 14B and 14C) are described, the number of nozzles 14 is variable according to the present invention. The apparatus 10 is operative with a single nozzle 14 opposite an aperture 25, but a plurality of nozzles 14 may be serially added on the dilution treatment chamber 12 to increase the efficiency of the operation taking place within the dilution treatment chamber 12.

Thereafter, the fine particle group exits through the outlet 31 at the bottom of the inner transfer chamber 30 of the transfer casing 13 after settling, whereas the coarse particle group continues its drop into the dilution treatment chamber 12 toward the outlet 22.

The Operation of the Apparatus in Mixing/Treating

As mentioned previously, the apparatus 10 of the present invention can also be used for mixing and/or treating particle and/or fluid streams. Therefore, a mixing/treating operation of the apparatus 10 is set forth.

Referring to FIG. 1, particle and/or fluid streams to mix/treat are fed by the conveyor C, and possibly other conveyors or particle and/or fluid sources (not shown) to the apparatus 10. The particle and/or fluid streams have a lateral velocity and will accelerate downwardly when leaving their source due to gravitational forces.

The slide 53 will absorb a portion of the downward force of the particle and/or fluid streams, and stop the lateral velocity of the particle and/or fluid streams that had been transferred thereto by the action of the conveyor C or other possible source. The particle and/or fluid streams are directed by the slide 53 toward the slide 50 of the pretreatment module 15, at generally predetermined velocity conditions.

Upon reaching the slide 50, the particle and/or fluid streams will be guided by the optional guiding rails 52 (FIG. 2) so as to be conveyed uniformly towards the dilution treatment chamber 12 as a result of the downward slope of the slide 50. The downward slope of the slide 50 will cause the particle and/or fluid streams to accelerate.

The deflector 51, having a launch surface, will deflect the particle and/or fluid streams horizontally. A lateral dilution will be the result of the deflection of the particle and/or fluid streams by the deflector 51. Accordingly, the particle and/or fluid streams will reach the dilution treatment chamber 12, having been subjected to a horizontal dilution.

The particle and/or fluid streams then falls in the channel 20 of the dilution treatment chamber 12. The gravity will cause a vertical dilution of the particle and/or fluid streams.

A first one of the nozzles, namely nozzle 14A, will laterally inject fluid, or any other suitable fluid or particle jet, within the channel 20 of the dilution treatment chamber 12 so as to cause a turbulence, a mix, or a treatment of the particle and/or fluid streams. The fluid/particle injected by the nozzle 14A is of predetermined pressure so as to have a variable effect relative to the size, mass and other characteristics of the particles and/or fluid streams. The nozzle 14A injects air, or any other suitable fluid, at high pressure and low volume.

The lateral outlets 24 are not used in the mixing process of the apparatus 10. The nozzles 14B and 14C are optionally used with the lateral outlets 24 being blocked, so as to create further turbulence, as it is contemplated to provide a plurality of the nozzles 14 to enhance the mixing of particle and/or fluid streams in the channel 20, or for treating the particle and/or fluid streams. Additional nozzles may also be added to the apparatus 10.

Thereafter, the mix or treated matter, resulting from the mix/treatment of the particle and/or fluid streams, continues its drop into the dilution treatment chamber 12 toward the outlet 22.

Additional Components of the Apparatus 10

It is contemplated to provide additional components to the apparatus 10 in order to optimize the separation of the particle stream into particle groups.

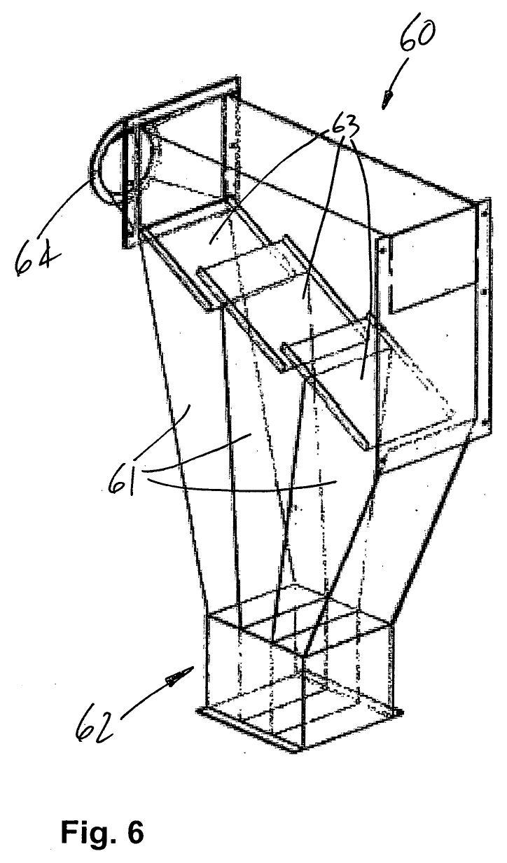

Referring to FIGS. 5 and 6, a lateral distributor is generally shown at 60. The lateral distributor 60 is positioned in the transfer chamber 30 of the transfer casing 13. Referring more specifically to FIG. 6 in which all reference numerals are shown to simplify FIG. 5, the lateral distributor 60 is shown defining three upstanding sectors 61, each converging to a segmented outlet portion 62. Each of the sector 61 has a respective collecting surface 63 upon which particles coming from the dilution treatment chamber 12 will be collected. An air flow outlet 64 is provided downstream of the upstanding sectors 61 to allow an appropriate flow of air, that will not impede on the lateral flow of air (or gaseous fluid) out of the lateral outlets 24 of the dilution treatment chamber 12.

More specifically, the lateral distributor 60 operates with the principle that the distance traveled by the particles carried in the flow of air from the dilution treatment chamber 12 is a function of the particle size parameters (e.g., surface area, mass). Accordingly, coarser particles will travel a shorter distance than finer ones, whereby the coarser particles will be collected by the upstream sector 61. Therefore, a further particle group separation takes place with the lateral distributor 60. The hence separated particle groups are collected separately at the segmented outlet portion 62.

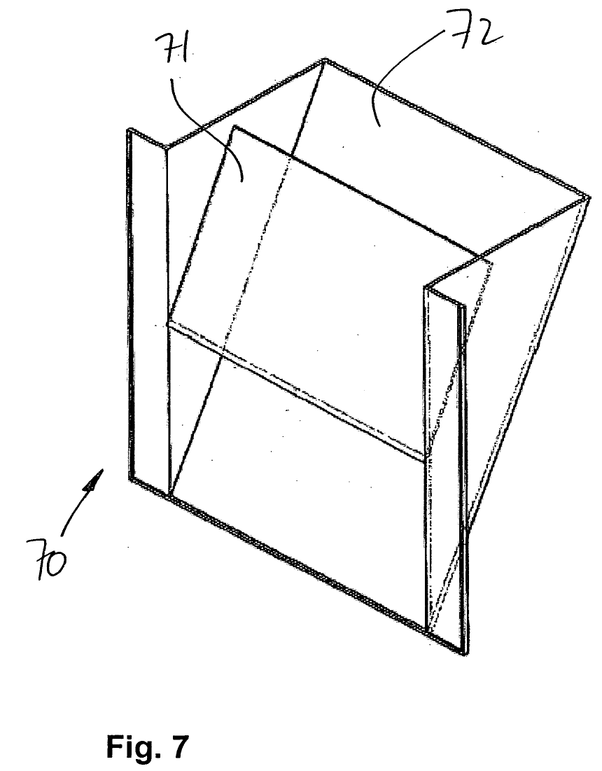

Referring to FIGS. 3 and 7, recuperation trays 70 are provided below each of the lateral outlets 24 of the dilution treatment chamber 12. More specifically, it is possible that particles that should selectively remain with the dilution treatment chamber 12 are deflected out of the lateral outlets 24. It is anticipated that these coarser particles will not travel a long distance out of the lateral outlets 24 due to their size parameters. Accordingly, the recuperation trays 70 are provided to collect these particles, as they are positioned directly below the apertures 24. These particles are returned to the dilution treatment chamber 12 by the sloping shape of the recuperation trays.

Moreover, the recuperation tray 70 illustrated in FIG. 7 also effects a particle separation. More specifically, the recuperation tray 70 as a first sector 71 and a second sector 72. The first sector 71 collects the particles that should not have left the dilution treatment chamber 12, whereas the second sector 72 collects rapidly falling particles, of a grade just below that of the particle group remaining within the dilution treatment chamber 12. It is pointed out that the second sector 72 is connected to its own outlet.

Also, the recuperation tray 70 may be pivotally connected at a bottom edge thereof to the wall of the dilution treatment chamber 12. This would enable adjustment of an angle of the recuperation tray 70 with regard to the vertical, as a function of the particle stream/particle group being separated.

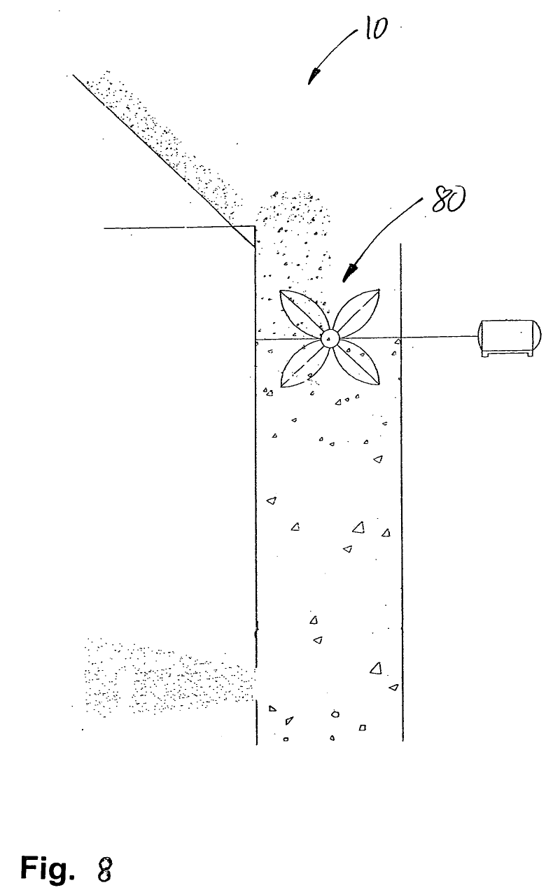

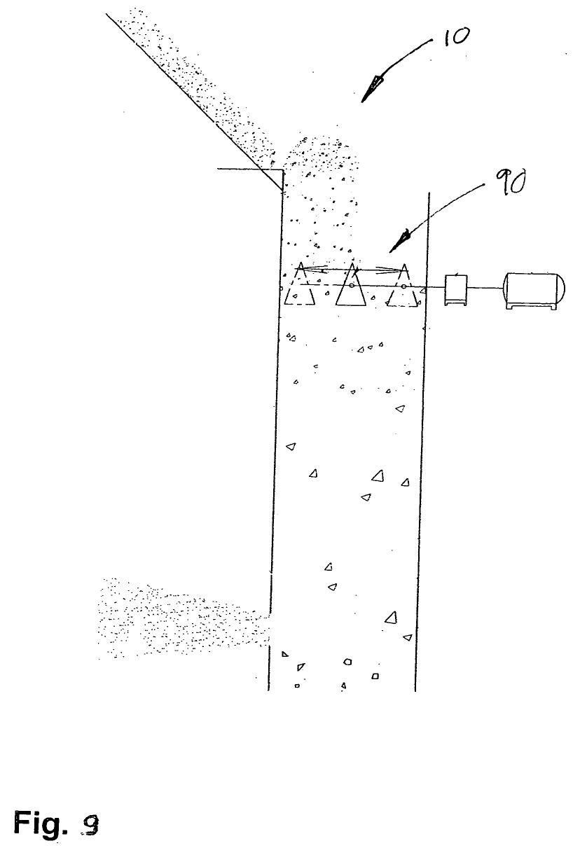

FIGS. 12 and 13 illustrate alternatives to the nozzle 14A for use in the dilution process. In FIG. 8, an impeller is shown at 80. In FIG. 9, a laterally reciprocating strainer is generally shown at 90. Both these alternatives will cause a horizontal dilution of the particle stream. Other alternatives include fans, electrostatic or magnetic emitters (e.g., in accordance with the type of particle stream being treated), as well as any mechanical or ultrasound system.

It is also contemplated to inject additives to the particle stream being diluted in the dilution treatment chamber 12. For instance, an aperture such as one of the pressure-differential apertures 25 can be used with a suitable injection system (e.g., blower and conduit combination) to inject color (e.g., in the form of a powder) to the particle stream being diluted in the dilution treatment chamber 12, or to particle groups being mixed therein.

It is also contemplated to provide a plurality of the apparatus 10 in series, with a conveying system transporting/conveying the output of an upstream one of the apparatus 10 to a downstream one. Alternatively, a pair (or more) of the apparatus 10 may be positioned in parallel and share a common transfer chamber 30, to collect a specific particle group. In such a case, the transfer chamber 30 could be used to mix a particle group from a first dilution treatment chamber 12 with a particle group of a second dilution treatment chamber 12.

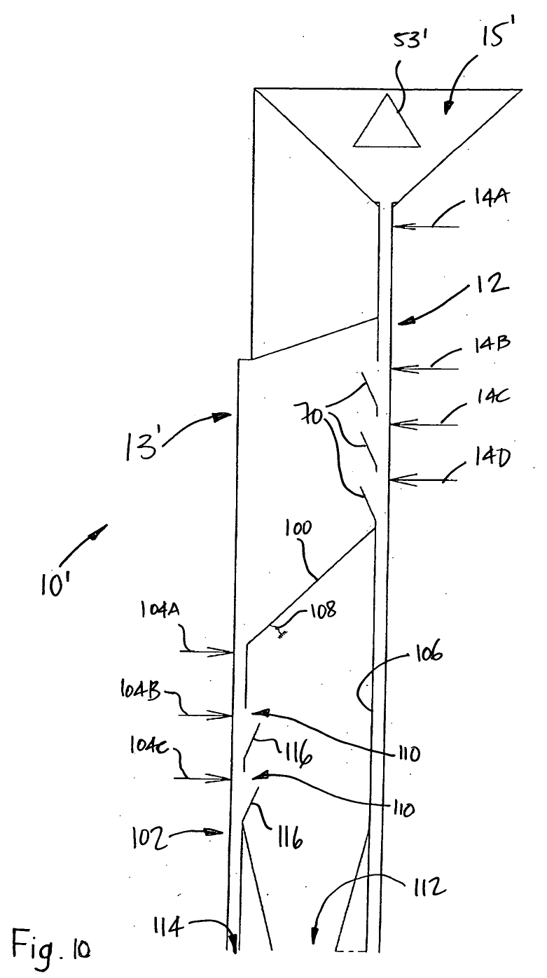

For instance, referring to FIG. 10, an apparatus in accordance with an alternative embodiment of the present invention is generally shown at 10′. The apparatus 10′ is similar to the apparatus 10 of FIG. 1 in that the apparatus 10′ has a dilution treatment chamber 12, nozzles 14 (herein four nozzles for the dilution treatment chamber 12) and an pretreatment module 15′. The pretreatment module 15′ shows a different shape (e.g., with a conical slide 53′), but operates in a fashion similar to that of the pretreatment module 15. The apparatus 10′ has a transfer casing 13′ in which a secondary separation is performed.

More specifically, the transfer casing 13′ has a transfer plate 100, a dilution treatment chamber 102, nozzles 104 and a subcasing 106. The particle group reaching the transfer casing 13′ from the dilution treatment chamber 12 will drop into the inlet of the dilution treatment chamber 102, or will settle onto the transfer plate 100, to then reach the inlet of the dilution treatment chamber 102.

Optionally, the transfer plate 100 is provided with a vibrator 108 so as to avoid having particles collect thereon. The transfer plate 100 could also be provided with a low adherence coating, such as PTFE.

The dilution treatment chamber 102 is illustrated having the nozzles 104A, 104B and 104C. The nozzle 104A serves the same function as the nozzle 14A of FIG. 1, namely to break down the particle group that has reached the dilution treatment chamber 102. The nozzle 104A can be replaced with other devices, such as those illustrated in FIGS. 12 and 13.

The nozzles 104B and 104C serve the same function as the nozzles 14B and 14C of FIG. 1, and are thus positioned opposite lateral outlets 110, through which a particle group will be forced, to reach the subcasing 106 and settle therein. The removed particle group will exit through outlet 112, whereas the particle group remaining in the dilution treatment chamber 102 will exit through outlet 114. Recuperation trays 116 are adjustable similarly to the recuperation trays 70 of the preferred embodiment.

Accordingly, the output of the apparatus 10′ is three particle groups, with the particle group exiting from the subcasing 106 being the finest. It is pointed out that the gaseous fluid output of the nozzles 14 and 104 is adjusted in view of the desired size of the particle groups. The transfer casing 13′ can be used for mixing, as described previously for the apparatus 10.

Uses

Amongst the various process that can take place with the apparatus 10 of the present invention, it is contemplated to separate, treat, classify (with an initial step of separation), mix, add, vaporize, clean, calibrate, or eliminate fines from particle streams. Other treatments, such as painting, coating, sandblasting or cleaning, can be effected with the apparatus 10 of the present invention. Existing batch processes, such as the injection of gas or chemicals into soft drinks, can be converted to continuous processes using the present invention.

The differential pressure in the dilution treatment chamber 12 can be controlled electronically and the apparatus 10 may be combined to magnetic, electrical, ultrasound, electronic and electromagnetic systems.

The apparatus 10 can be used with mineral, vegetable, biological, organic aggregates, as well as with fertilizers, treatment or transformation residues, waste, food products, drugs and other pharmaceutical products, powders, agriculture related products, chemical or metallurgical products, compost, plastics and composites, paper, soil and bio-soil, ashes, crushed stone, ceramics, coal.

The apparatus 10 of the present invention is relatively small. Accordingly, it is possible to place the apparatus 10 at various parts of a process due to these advantageous features. The apparatus 10 enables large quantities of particles/fluid streams to be treated in a relatively limited amount of space, with little wear of material, low energy consumption and, in some embodiments, no moving parts (i.e., depending on the choice of the type of dilution).

The apparatus 10 can be used as part of a multi-step or multi-pass process. Moreover, although the preferred embodiment includes only a settling cavity for the collection of particles, an outflow of air for the particles remaining in suspension can be added as an option. The apparatus 10 is made of rigid materials, such as metals, polymers, etc . . . It is pointed out that aside from the slide 53, the apparatus 10 goes through limited wear.

It is within the ambit of the present invention to cover any obvious modifications of the embodiments described herein, provided such modifications fall within the scope of the appended claims.

I claim:

1. An apparatus for separating a particle stream into particle groups, comprising:
a dilution treatment chamber defining an upstanding channel having a particle inlet at a top end, and a first-particle group outlet at a bottom end, the channel being adapted to receive a particle stream at the particle inlet such that the particle stream falls toward the first-particle-group outlet;
a transfer casing adjacent to the dilution treatment chamber and defining a transfer chamber adapted to receive a second particle group;
at least one second-particle-group outlet laterally positioned with respect to the channel of the dilution treatment chamber and allowing fluid communication between the transfer chamber and the channel;
a distributor in the channel between the particle inlet and the at least one second-particle-group outlet, for breaking down the particle stream and distributing the particle stream over a surface area of the channel; and
at least one fluid flow aperture in the dilution treatment chamber and below the distributor, adapted to create a fluid flow between the transfer chamber and the channel so as to entrain a second particle group from the channel through the second-particle-group outlet to the transfer chamber with a first particle group remaining in the channel for exiting through the first-particle-group outlet, the apparatus being adapted to be connected to a positive pressure source to create the fluid flow.

2. The apparatus according to claim 1, further comprising a pretreatment module at the particle inlet of the dilution treatment chamber, to guide the particle stream and to cause a horizontal dilution of the particle stream.

3. The apparatus according to claim 2, wherein the pretreatment module has at least one slide portion sloping downwardly toward the particle inlet of the dilution treatment chamber for guiding and accelerating a particle stream to the dilution treatment chamber, and a deflecting surface between the slide and the particle inlet for breaking down the particle stream and for imparting the horizontal dilution to the particle stream.

4. The apparatus according to claim 1, wherein at least one of the fluid flow apertures is used to inject an additive into the first particle group.

5. The apparatus according to claim 1, wherein the at least one second-particle-group outlet and the at least one fluid flow aperture are horizontally aligned and on opposite sides of the channel of the dilution treatment chamber.

6. The apparatus according to claim 5, wherein a nozzle adapted to be connected to the positive pressure source is connected to the fluid flow aperture so as to inject fluid in the channel to create the fluid flow between the channel and the transfer chamber.

7. The apparatus according to claim 1, wherein the distributor has an aperture laterally positioned in the channel, and a fluid-injection nozzle adapted to be connected to the positive pressure source and connected to the dilution aperture for injecting fluid in the channel of the dilution treatment chamber, for breaking down the particle stream and distributing the particle stream over a surface area of the channel.

8. The apparatus according to claim 1, wherein the distributor has one of an impeller, an ultrasound system and a reciprocating strainer.

9. The apparatus according to claim 1, further comprising a recuperation tray, positioned out of the channel in the transfer chamber and below the second-particle-group outlet for collecting particles of the first particle group deflected or forced out of the channel by the flow of fluid, and for returning the particles of the first particle group to a remainder of the first particle group.

10. The apparatus according to claim 1, wherein the transfer casing has an outlet at a bottom end thereof, for collecting the second particle group received in the transfer casing.

11. The apparatus according to claim 1, wherein the transfer chamber of the transfer casing is segmented into laterally adjacent upstanding receptacles to further separate the second particle group according to the distance over which the particles of the second particle group are entrained by the flow of fluid.

12. A method for separating a particle stream into particle groups, comprising the steps of:
i) vertically diluting the particle stream by directing the particle stream to a falling condition within a channel;
ii) breaking down the particle stream by subjecting the particle stream to lateral forces so as to distribute the particle stream over a surface area of the channel;
iii) entraining a particle group away from a remainder of the particle stream by creating a fluid flow of predetermined magnitude across the particle stream in said falling condition; and
iv) collecting the particle group and the remainder of the particle stream at separate locations.

13. The method according to claim 12, further comprising a step of horizontally diluting the particle stream by providing a horizontal velocity to the particle stream prior to step i).

14. The method according to claim 12, wherein step ii) includes injecting a fluid into the particle stream to break down said mass and distribute the particle stream over the surface area of the channel.

15. The method according to claim 12, wherein step iv) includes collecting the particle group into at least two particle subgroups by providing at least two collecting locations for the particle group, so as to collect particles in the subgroups according to a distance of entrainment of the particles.

16. An apparatus for at least one of mixing and treating particle and/or fluid streams, comprising:
a dilution treatment chamber defining an upstanding channel having an inlet at a top end, and an outlet, the channel being adapted to receive said particle and/or fluid streams at the inlet such that said particle and/or fluid streams fall toward the outlet;
at least one fluid flow aperture in the dilution treatment chamber, adapted to create a generally lateral flow of at least one of a fluid and particle jet within the channel to create a turbulence in the channel for at least one of mixing said particle and/or fluid streams and treating said particle and/or fluid streams, whereby a mixture and/or treated matter will exit the channel at the outlet; and
a positive pressure source connected to the fluid flow aperture to create the lateral flow of the at least one of the fluid and the particle jet.

17. The apparatus according to claim 16, further comprising a particle pretreatment module at the inlet of the dilution treatment chamber, to cause a horizontal dilution of said particle and/or fluid streams.

18. The apparatus according to claim 17, wherein the particle pretreatment module has at least one slide portion sloping downwardly toward the inlet of the dilution treatment chamber for guiding said particle and/or fluid streams to the dilution treatment chamber, and a deflector surface between the slide and the inlet for breaking down said particle and/or fluid streams and for imparting the horizontal dilution to said particle and/or fluid streams.

19. The apparatus according to claim 16, wherein a nozzle interconnects the pressure source to the fluid flow aperture so as to create the flow of fluid in the channel.

20. A method for at least one of treating and mixing particle and/or fluid streams, comprising the steps of:
i) vertically diluting particle and/or fluid streams by directing particle and/or fluid streams to a falling condition;
ii) creating a lateral flow of fluid and/or a particle jet across the particle and/or fluid streams in said falling condition for at least one of mixing the particle and/or fluid streams by a turbulence resulting from the lateral flow of fluid and/or particle jet, and treating said particle and/or fluid streams; and
iii) collecting the mixture and/or treated matter below the lateral flow.

21. The method according to claim 20, further comprising a step of horizontally diluting the particle and/or fluid streams by providing a horizontal velocity to the particle and/or fluid streams prior to step i).
